(19) United States
(12) Patent Application Publication
(10) Pub. No.: US 2021/0238923 A1
(43) Pub. Date: Aug. 5, 2021

(54) LADDER

(71) Applicant: John Onderwater, Maple Ridge (CA)

(72) Inventor: John Onderwater, Maple Ridge (CA)

(21) Appl. No.: 16/780,992

(22) Filed: Feb. 4, 2020

(51) Int. Cl. E06C 1/22; E06C 1/39; E06C 7/00; E06C 7/06; E06C 7/08; E06C 7/44

(52) U.S. Cl. CPC E06C 1/22; E06C 1/39; E06C 7/44; E06C 7/06; E06C 7/08; E06C 7/003

(57) ABSTRACT

A ladder having a frame with three leg members wherein the leg members are adjustable in length so as to provide a level orientation of the ladder subsequent the ladder being superposed an uneven support surface. The frame includes two rear leg members and a front leg member having a platform member operably coupled to the top thereof. The front leg member is hingedly secured to the platform member and movable between a deployed and stored position. The three leg members include an upper portion and a lower portion wherein the lower portion is slidably engaged with the upper portion. A clamp member is disposed in each of the three leg members and is configured to operably engage a portion of the lower portion of each of the three leg members. The clamp member includes opposing jaw members with a void therebetween.

### FIELD OF THE INVENTION

The present invention relates generally to elevation attaining apparatus, more specifically but not by way of limitation, a ladder that is configured to be adjustable so as to ensure a level orientation for the rungs on which a user will climb to attain a height unreachable without the ladder for purposes such as but not limited to performing household maintenance.

### BACKGROUND

Apparatus such as but not limited to scaffolding and ladders are well known in the art and are utilized to perform a variety of tasks. In particular, ladders are available in various styles and sizes and are commonly used by tradespeople and homeowners alike. One popular style of ladder is an extension ladder. This type of ladder is often used for reaching higher locations due to the configuration thereof. Conventional extension ladders are constructed utilizing two sets of opposing rail members wherein the rail members have step members perpendicular therebetween. The opposing rail members are configured to slidably telescope so as to provide alternate height options for a user. These types of ladders are typically biased against the structure on which a user desires to reach a part thereof. The other type of conventional ladder is a step ladder. The step ladder typically comprises of a first side and second side that are hingedly moved with respect to each other wherein each side has opposing side rail members. One side of the ladder is equipped with step members that provide a plurality of support surfaces for a user to climb. These step ladders can vary in height and size but most provide a configuration that offer four legs that are engaged with the support surface on which the ladder is superposed.

One problem with conventional ladders is the ability to provide a level orientation of the step members when the ladder is placed on an uneven support surface. By way of example but not limitation, when a conventional ladder is utilized to trim a tree or shrub, the ladder is typically placed on the ground adjacent thereto. A typical ground environment near a tree or shrub is often not level and as a result the ladder is often biased in an angular orientation. The angular orientation of the ladder and as such the step members results in an unstable ladder and presents risk to the user climbing thereon.

It is intended within the scope of the present invention to provide a step ladder that is configured to have adjustable leg members wherein the adjustable leg members are configured to ensure a level orientation of the step members of the ladder and a secure positioning of the ladder on various surfaces.

### SUMMARY OF THE INVENTION

It is the object of the present invention to provide a ladder that is configurable to ensure a level orientation of the step members thereof wherein the ladder of the present invention includes a frame having three leg members.

Another object of the present invention is to provide a ladder that is operable to ensure a stable platform for a user superposed thereon regardless of the condition of the surface on which the ladder is superposed wherein the frame includes a single front leg member that is hingedly movable with respect to two rear leg members.

A further object of the present invention is to provide a ladder that is configurable to ensure a level orientation of the step members thereof wherein the rear legs and front leg further include movable sections proximate the ends thereof.

Still another object of the present invention is to provide a ladder that is operable to ensure a stable platform for a user superposed thereon regardless of the condition of the surface on which the ladder is superposed wherein the movable sections of the front leg and rear legs of the present invention are controlled by clamp members disposed in the rear legs and front leg.

An additional object of the present invention is to provide a ladder that is configurable to ensure a level orientation of the step members thereof wherein the clamp members further include a first portion and a second portion that are configured to be biased towards each other so as to retain a portion of the movable sections of the rear legs and front leg therein.

Yet a further object of the present invention is to provide a ladder that is operable to ensure a stable platform for a user superposed thereon regardless of the condition of the surface on which the ladder is superposed wherein the movable sections of the rear leg members and front leg member further include a foot plate member.

Another object of the present invention is to provide a ladder that is configurable to ensure a level orientation of the step members thereof wherein the front leg member is mechanically biased in its deployed position by a keeper.

An alternate object of the present invention is to provide a ladder that is operable to ensure a stable platform for a user superposed thereon regardless of the condition of the surface on which the ladder is superposed wherein the ladder of the present invention further includes a first level and a second level so as to indicate the orientation of the ladder ensuing placement thereof.

Still a further object of the present invention is to provide a ladder that is configurable to ensure a level orientation of the step members thereof wherein the movable sections of the front leg and rear legs are secured ensuing deployment utilizing a locking pin.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side perspective view of the present invention; and

FIG. 2 is a detailed portion of the top of the present invention; and

FIG. 3 is a detailed view of a rear leg member of the present invention; and

FIG. 4 is a detailed view of the rail clamp member of the present invention; and

FIG. 5 is a detailed view of a rear leg member of the present invention.

### DETAILED DESCRIPTION

References now to the drawings submitted herewith, wherein various elements depicted therein are not necessarily drawn to scale and wherein through the views and figures like elements are referenced with identical reference numerals, there is illustrated a ladder 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

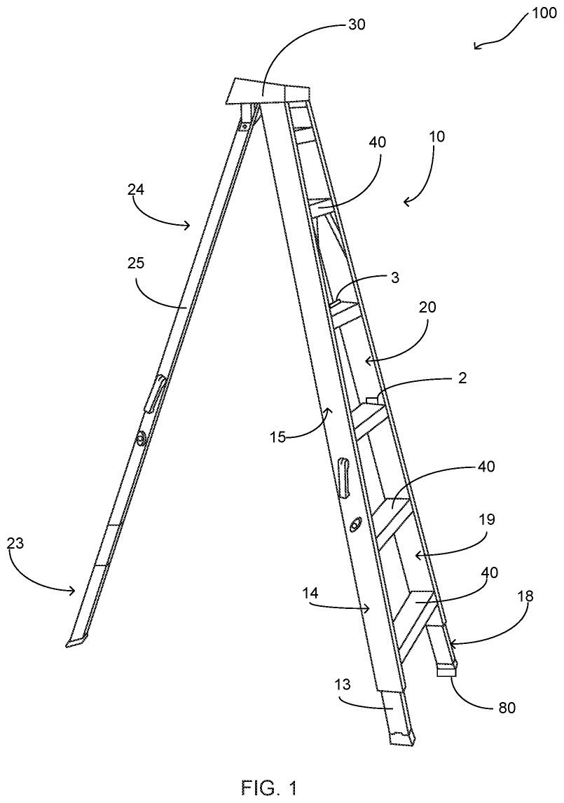

Now referring to the Figures submitted herewith, the ladder 100 includes a frame 10. The frame 10 is manufactured from a suitable durable material such as but not limited to aluminum. The frame 10 includes a first rear leg member 15, a second rear leg member 20 and a front leg member 25 that are operably coupled. The first rear leg member 15, second rear leg member 20 and front leg member 25 are operably coupled to platform member 30 wherein the platform member 30 is proximate the upper end 5 of the frame 10. The front leg member 25 is hingedly coupled to the platform member 30 and is configured to be moved between a stored position and a deployed position wherein the deployed position of the front leg member 25 is illustrated herein in FIG. 1. The platform member 30 is manufactured from a durable rigid material such as but not limited to aluminum. The front leg member 25 is hingedly secured to the bottom surface of the platform member 30. The frame 10 further includes a plurality of step members 40 wherein the step members 40 are perpendicular to the first rear leg member 15 and second rear leg member 20 and extend therebetween. The step members 40 are manufactured from a suitable durable material such as but not limited to aluminum. The step members 40 are secured utilizing techniques such as but not limited to welding or mechanical fasteners. It should be understood within the scope of the present invention that the ladder 100 could have various quantities of step members 40 as it is intended within the scope of the present invention that the ladder 100 could be manufactured in alternate heights.

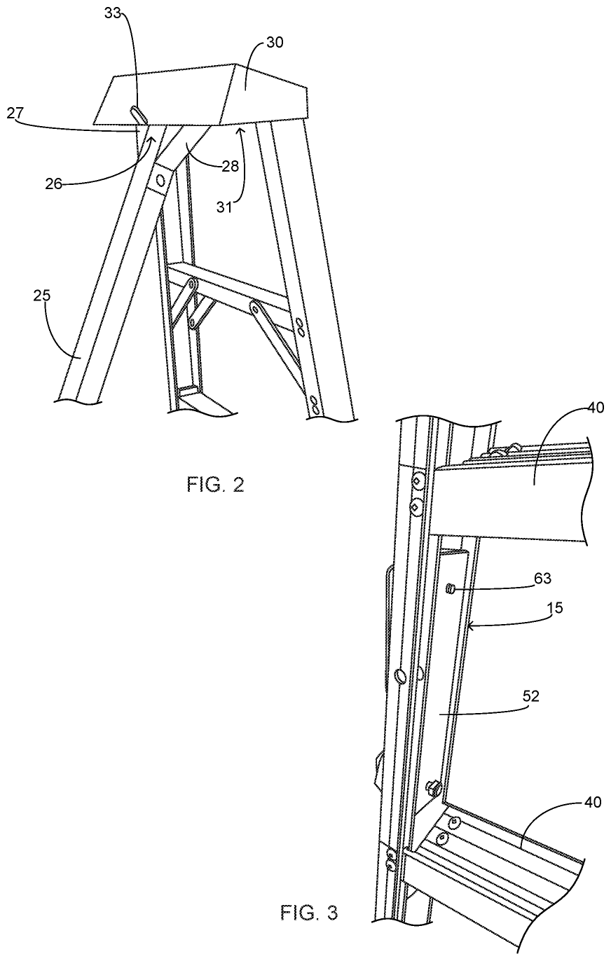

Referring in particular to FIG. 2, the front leg member 25 has an upper end 26 that is hingedly secured to the bottom 31 of the platform member 30. Secured to the upper end 26 are a pair of opposing lateral support members 27,28 that angularly extend outward from the upper end 26 and are hingedly secured to the bottom 31 of the platform member 30. The pair of opposing lateral support members 27 provide structural support for the front leg member 25 and are manufactured from a durable material such as but not limited to aluminum. A keeper 33 is secured to the platform member 30. The keeper 33 is configured to operably engage the front leg member 25 and secure the front leg member 25 in its deployed position. It should be understood within the scope of the present invention that the keeper 33 could be manufactured utilizing various components and techniques and still achieve the desired function described herein.

The front leg member 25 includes an upper portion 24 and a lower portion 23 wherein the lower portion 23 is movably coupled to the upper portion 24 so as to provide adjustment of the overall length of the front leg member 25. The movement of the lower portion 23 and positioning thereof is controlled by the clamp member 50 as will be further discussed herein. It should be understood within the scope of the present invention that the lower portion 23 could be manufactured in alternate lengths in order to provide varying lengths of the overall front leg member 25.

The first rear leg member 15 further includes a lower portion 13 that is moveably coupled to the upper portion 14. The lower portion 13 is slidably engaged with the upper portion 14 and the clamp member 50 facilitates the adjustment and position control thereof. The ladder 100 includes three clamp members 50 that are further discussed herein wherein the front leg member 25, first rear leg member 15 and second rear leg member 20 all have a clamp member 50 operably disposed therein. The second rear leg member 20 includes a upper portion 19 and a lower portion 18 wherein the lower portion 18 is slidably coupled with the upper portion 19 in order to provide alteration of the length of the second rear leg member 20. The front leg member 25, first rear leg member 15 and second rear leg member 20 all include upper portions and lower portions wherein the lower portions are moveable with respect to the upper portions. Each lower portion of the front leg member 25, first rear leg member 15 and second rear leg member 20 is independently movable so as to facilitate the level orientation of the ladder 100 on various support surfaces. The ladder 100 includes a first level 2 and a second level 3 wherein the first level 2 and second level 3 are conventional bubble levels and are operable to provide a visual indication that the ladder 100 is level ensuing placement thereof and adjustment of the lower portions of the front leg member 25, first rear leg member 15 and second rear leg member 20.

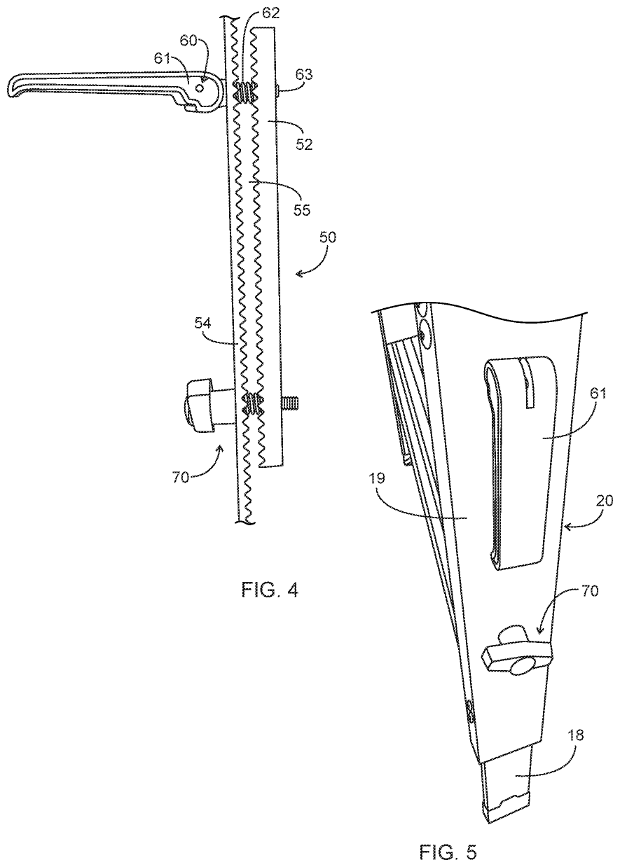

Now referring in particular to FIG. 4, the clamp member 50 is illustrated therein. As previously discussed a clamp member 50 is operably disposed in each of the front leg member 25, first rear leg member 15 and second rear leg member 20 and is configured to provide adjustment of the lower portions thereof. The clamp member 50 includes a first jaw member 52 and a second jaw member 54. The first jaw member 52 and second jaw member 54 are manufactured from a suitable durable material such as but not limited to aluminum. The first jaw member 52 and second jaw member 54 are operably coupled utilizing fastener 60 and further include a void 55 therebetween. The fastener 60 is configured to alter the width of the void 55 so as to allow movement of a lower portion of the front leg member 25, first rear leg member 15 and second rear leg member 20 and be subsequently adjusted to secure the lower portion in position such that a section of a lower portion is biased in between the first jaw member 52 and second jaw member 54. The fastener 60 is a conventional spring biased fastener having a handle 61, spring 62 and bolt 63 wherein the handle 61 provides the user interface to either release or apply force of the clamp member 50 in order to provide adjustment of a lower portion. While a particular style of fastener 60 is illustrated herein, it is contemplated within the scope of the present invention that the clamp member 50 could employ alternate types of mechanical fasteners in order to achieve the desired objective of controlling the first jaw member 52 and second jaw member 54. The clamp member 50 further includes securing pin 70 that is operably coupled to the clamp member 50 distal to the fastener 60. The securing pin 70 is operable to be journaled through apertures (not particularly illustrated herein) that are formed through the clamp member 50, and upper portions and lower portions of the front leg member 25, first rear leg member 15 and second rear leg member 20. The securing pin 70 ensures that a lower portion of the front leg member 25, first rear leg member 15 and second rear leg member 20 is immovable and stable ensuing a desired positioning thereof. It is contemplated within the scope of the present invention that the securing pin 70 could be constructed utilizing alternate styles of mechanical fasteners.

As shown in FIG. 1 herein, a foot plate member 80 is secured to the lower portion 18 of the second rear leg member 20. The foot plate member 80 is manufactured from a durable rigid material such as but not limited to aluminum. The foot plate member 80 is perpendicular with the lower portion 18 and is secured to the end thereof. The foot plate member 80 is provided so as to facilitate engagement with a bottom of a shoe of a user of the ladder 100 wherein the clamp member 50 can be loosened to permit movement of the lower portion 18 to a desired position while being biased in place under the shoe of a user and then secured into position. This allows the user to engage the second rear leg member 20 and first rear leg member 15 with their hands and use the foot plate member 80 under their shoe to provide length adjustment of the lower portion 18. While not particularly illustrated herein, it should be understood that a foot plate member 80 is present on the first rear leg member as well.

While various embodiments of the ladder 100 have been illustrated and discussed herein, it is contemplated within the scope of the present invention that a preferred embodiment of the ladder 100 is provided wherein the first rear leg member 15 is a fixed length while the front rear leg member 25 and second rear leg member 20 are adjustable in length as illustrated and discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A ladder configurable to provide a level orientation for a user thereof during the ladder being superposed on an uneven support surface wherein the ladder comprises:
a frame, said frame including a front leg member, a first rear leg member and a second rear leg member, said front leg member having an upper end and lower end, said first rear leg member having an upper end and a lower end, said second rear leg member having an upper end and a lower end, said frame further including a platform member, said platform member being operably coupled to the upper end of the front leg member, first rear leg member and second rear leg member, said front leg member being hingedly secured to said platform member, wherein the front leg member, first rear leg member and second rear leg member further include an upper portion and a lower portion, the lower portion of at least the front leg member, first rear leg member or second rear leg member being movably coupled with the upper portion of the front leg member, first rear leg member and second rear leg member;
a plurality of step members, said step members being operably coupled between said first rear leg member and said second rear leg member, said plurality of step members being perpendicular to the first rear leg member and second rear leg member; and
at least one clamp member, said at least one clamp member being disposed in either the front leg member, first rear leg member or second rear leg member, said at least one clamp member operable to provide control of the lower portion of either the front leg member, first rear leg member or second rear leg member with respect to the upper portion of either the front leg member, first rear leg member or second rear leg member wherein movement of the lower portion of either the front leg member, first rear leg member or second rear leg member provides adjustment of the ladder and a level orientation thereof.

2. The ladder configurable to provide a level orientation as recited in claim 1, wherein said at least one clamp member includes a first jaw member and a second jaw member, wherein said first jaw member and said second jaw member are operably coupled.

3. The ladder configurable to provide a level orientation as recited in claim 2, wherein said first jaw member and said second jaw member of said at least one clamp member has a void therebetween.

4. The ladder configurable to provide a level orientation as recited in claim 3, wherein the void of said at least one clamp member is operable to receive therein a section of the lower portion of either the front leg member, first rear leg member or second rear leg member and bias thereagainst.

5. The ladder configurable to provide a level orientation as recited in claim 4, and further including a keeper, said keeper being operably coupled to said platform member, said keeper configured to operably engage the front leg member, said keeper operable to retain said front leg member in a deployed position.

6. The ladder configurable to provide a level orientation as recited in claim 5, wherein said first rear leg member further includes a foot plate member, said foot plate member being secured to the lower portion of either the first rear leg member, second rear leg member or front leg member, said foot plate member being perpendicular to the lower portion of the first rear leg member.

7. The ladder configurable to provide a level orientation as recited in claim 6, and further including at least one level, said at least one level operable to provide visual verification of a level orientation of the ladder.

8. A ladder configured to allow adjustment of the leg members thereof so as to ensure a level orientation for a user superposed thereon wherein the ladder comprises:
a frame, said frame being manufactured from a rigid lightweight metal or wood;
a first rear leg member, said first rear leg member having an upper portion and a lower portion;
a second rear leg member, said second rear leg member having an upper portion and a lower portion, said lower portion of said second rear leg member being slidably coupled with said upper portion of said second rear leg member, said second rear leg member having a clamp member disposed in the upper portion thereof, said clamp member of said second rear leg member configured to provide adjustment of an overall length of said second rear leg member;
a front leg member, said front leg member having an upper portion and a lower portion, said lower portion of said front leg member being slidably coupled to said upper portion of said front leg member, said front leg member having a clamp member disposed in the upper portion thereof, said clamp member of said front leg member configured to operably engage said lower portion of said front leg member, said lower portion of said front leg member movable so as to alter an overall length of said front leg member; and
a plurality of step members, said step members being operably coupled between said first rear leg member and said second rear leg member, said plurality of step members being perpendicular to the first rear leg member and second rear leg member.

9. The ladder configured to allow adjustment of the leg members as recited in claim 8, wherein the first rear leg member is provided in a fixed length.

10. The ladder configured to allow adjustment of the leg members as recited in claim 9, and further including a platform member, said platform member being located at a upper end of the frame, said platform member being operably coupled to said front leg member, said first rear leg member and said second rear leg member, said front leg member being hingedly secured to said platform member.

11. The ladder configured to allow adjustment of the leg members as recited in claim 10, wherein the clamp member of the second rear leg member includes a first jaw and a second jaw, said first jaw and second jaw of said clamp member of the second rear leg member having a void therebetween operable to receive a section of the lower portion of the second rear leg member, said first jaw member and said second jaw member of the clamp member of said second rear leg member having a fastener operable to provide a bias against the section of the lower portion of the second rear leg member disposed between the first jaw member and second jaw member of the second rear leg member.

12. The ladder configured to allow adjustment of the leg members as recited in claim 12, and further including a first level and a second level, said first level and said second level being secured to said frame, said first level and said second level configured to provide visual confirmation of level orientation of the ladder.

13. The ladder configured to allow adjustment of the leg members as recited in claim 12, wherein the clamp member of the front leg member includes a first jaw and a second jaw, said first jaw and second jaw of said clamp member of the front leg member having a void therebetween operable to receive a section of the lower portion of the front leg member, said first jaw member and said second jaw member of the clamp member of said front leg member having a fastener operable to provide a bias against the section of the lower portion of the front leg member disposed between the first jaw member and second jaw member of the front leg member.

14. The ladder configured to allow adjustment of the leg members as recited in claim 13, wherein the first rear leg member further includes a foot plate member, said foot plate member of said first rear leg member being perpendicular to the first rear leg member and being planar in manner, said foot plate member being planar in manner and positioned so as to be engaged by a foot of a user of the ladder.

15. The ladder configured to allow adjustment of the leg members as recited in claim 14, and further including a keeper, said keeper being operably coupled to said platform member, said keeper configured to operably engage the front leg member, said keeper operable to retain said front leg member in a deployed position.

16. The ladder configured to allow adjustment of the leg members as recited in claim 15, wherein the second rear leg member further includes a foot plate member, said foot plate member of said second rear leg member being secured to said lower portion of said second rear leg member, said foot plate member of said second rear leg member being perpendicular to the lower portion of the second rear leg member and being planar in manner, said foot plate member of said second rear leg member being planar in manner and positioned so as to be engaged by a foot of a user of the ladder.

17. The ladder configured to allow adjustment of the leg members as recited in claim 16, wherein the clamp member of the first rear leg member further includes a pin, said pin operable to journal through said first jaw member and said second jaw member of said clamp member of said first rear leg member and further said upper portion and said lower portion of said first rear leg member.

18. The ladder configured to allow adjustment of the leg members as recited in claim 17, wherein the clamp member of the second rear leg member further includes a pin, said pin operable to journal through said first jaw member and said second jaw member of said clamp member of said second rear leg member and further said upper portion and said lower portion of said second rear leg member.

19. The ladder configured to allow adjustment of the leg members as recited in claim 18, wherein the clamp member of the front leg member further includes a pin, said pin operable to journal through said first jaw member and said second jaw member of said clamp member of said front leg member and further said upper portion and said lower portion of said front leg member.
